(19) United States
(12) Patent Application Publication
(10) Pub. No.: US 2022/0266762 A1
(43) Pub. Date: Aug. 25, 2022

(54) Underslung Bike Rack For Hitch

(71) Applicant: Curt Manufacturing, LLC, Eau Claire, WI (US)

(72) Inventors: Curtis M. Bowe, Chippewa Falls, WI (US); Ezekiel Hollaren, Baltic, SD (US)

(21) Appl. No.: 17/679,860

(22) Filed: Feb. 24, 2022

Related U.S. Application Data
(60) Provisional application No. 63/153,227, filed on Feb. 24, 2021.

(51) Int. Cl. B60R 9/10; B60R 9/06

(52) U.S. Cl. CPC B60R 9/10; B60R 9/06

(57) ABSTRACT

A bike rack which is mountable from a traditional hitch receiver and includes a main beam extending upwardly and rearwardly off a post. The main beam includes a lower section which is hinged to the post and holds one or more preferably two bikes each with their top tube extending horizontally and transversely under the lower section, as well as an upper section which is hinged to the lower section and holds one or more preferably two bikes each with their top tube similarly under the upper section. Each bike is placed with its top tube received in two pivotable, spaced oblong mounts. Two bikes can be mounted while the upper section is folded over, before unfolding/extending the upper section to mount the third and fourth bikes.

### CROSS-REFERENCE TO RELATED APPLICATION(S)

The present application claims priority from U.S. Provisional Application No. 63/153,227 entitled UNDERSLUNG BIKE RACK FOR HITCH filed Feb. 24, 2021, incorporated herein by reference.

### BACKGROUND OF THE INVENTION

The present application relates to bicycle support racks, and particularly to bicycle support racks which are mounted from a vehicle, such as in a hitch receiver used for towing loads off the back of the towing vehicle.

Many such bike racks are known. Generalized primary questions with regard to any vehicle mounted bike rack include the orientation of the bike(s) relative to the vehicle and where on the bike(s) are the support forces going to be applied to hold the bike in position during vehicle travel.

FIG. 1 shows a common frame style used on bikes, presented to identify nomenclature used on different frame parts. In particular, this bike 10 includes a frame 12 with three primary metal tubular parts which generally form a triangle: a toptube 14, a seat tube 16 and a downtube 18. The toptube 14 and the downtube 18 are each welded to a headtube 20 at their front ends. The downtube 18 and the seat tube 16 are welded to a bottom bracket shell 22 at their lower ends. The rear end of the toptube 14 is welded to an upper end of the seat tube 16. The front wheel 24 supports a front fork 26 which pivots within the headtube 20 as controlled by the handlebars 28 to allow steering of the bike 10. The rear wheel 30 supports the frame 12 at two dropouts 32. A chainstay 34 connects each rear dropout 32 to the bottom bracket shell 22, and a seatstay 36 connects each rear dropout 32 to the top of the seat tube 16.

Some vehicle mounted bike racks, including as described in U.S. Pat. Nos. 5,996,870 and 10,850,678, mount the bike(s) 10 with their wheels 24, 30 in the longitudinal direction, often with the front wheel 24 much higher than the rear wheel 30 of the bike 10. Some, including as described in U.S. Pat. No. 5,526,971, still require lifting one of the bike wheels 24, 30 significantly higher than the other wheel 24, 30 even if the bicycle 10 is transversely mounted. Others, including as described in U.S. Pat. Nos. 5,025,932, 5,476,203, 5,862,966, 5,947,357, 6,089,430, 6,626,340, 7,240,816, 9,102,280, 9,555,744, and 10,668,866, mount the bike(s) 10 transversely with the two bike wheels 24, 30 at the same elevation, but primarily support the bike(s) 10 from the wheels 24, 30, usually from below. All of these patents are incorporated by reference for their teaching of the problems and mounting environment.

The present invention is more particularly directed to bicycle support racks which mount the bike(s) 10 transversely, but hang the bike(s) from above, such as from the tops of the wheels 24, 30, or more preferably from the bike frame(s) 12, such as in U.S. Pat. Nos. 5,067,641, 5,647,521, 5,803,330 and 6,123,498. The designs of the frame mounts used on any of these prior art bike racks are incorporated by reference.

Vehicle mounted bike racks should be easy to use, both in attaching and detaching the bike rack to and from the towing vehicle, and in attaching and detaching the bike(s) 10 to the bike rack. For all hitch mounted bike racks, ease of loading of the bike(s) 10 to the rack is an important consideration. Many prior art bike racks force the user to perform a difficult lifting motion with the bike 10 to position the bike 10 on the bike rack. Some require lifting the bike 10 such that at least one of its wheels 24, 30 is elevated with its bottom three feet or more above the pavement. Others require the users to extend their arms while holding the weight of the bike 10, passing a rearward cradle to get to a forward cradle, etc. The bike positioning can be significantly more difficult as more bikes 10 are being supported. Older or weaker users often find the bicycle loading process too strenuous, likely to lead to personal injury or result in dropping or otherwise damaging the bike 10.

Vehicle mounted bike racks should be strong and secure for support of the bike(s) 10 while minimizing the possibilities of damage to the bike(s), providing sufficient clearance between the bike 10 and the towing vehicle (not shown) to avoid contact during towing as well as during mounting and dismounting the bike 10 from the bike rack. Vehicle mounted bike racks should be robust for a long product life, while still being light in weight and low in cost. Better vehicle mounted bike rack solutions are needed.

### BRIEF SUMMARY OF THE INVENTION

The present invention is a bike rack mountable from a traditional hitch receiver that includes a main beam extending off a post. In one aspect, the main beam slants rearwardly and upwardly from a top of the post, and a plurality of mounts are supported by the main beam for hanging at least one bike with a toptube of the bike extending substantially horizontally and transversely beneath the main beam. This allows the user to mount bike(s) from the rear without having to lift the bike over the main beam. For instance, the mounts can contact and support the toptube of the bike. In another aspect, the main beam is foldable, so a first bike can be loaded while the main beam is folded, and a subsequent bike can be loaded after to main beam has been unfolded. The main beam is preferably hinged to the post, so the main beam can also be dropped down to a more compact storage position adjacent the post when attached to the towing vehicle but not supporting any bikes.

### BRIEF DESCRIPTION OF THE DRAWINGS

FIG. 1 is a perspective view of a bicycle using a common frame style, considered part of the prior art with which the present invention can be used.

FIG. 2 is a perspective view from the upper-rear-right, of a first preferred embodiment of a vehicle mounted bike rack in accordance with the present invention, used with a quick mount adapter, four supporting up to four of the bikes of FIG. 1.

FIG. 3 is a rear view of the bike rack of FIG. 2.

FIG. 4 is a side view of the bike rack of FIGS. 2 and 3.

FIG. 5 is a perspective view from the upper-rear-right of the bike rack of FIGS. 2-4, shown with the main beam in a folded position for support up to two bikes and/or for loading of the first two bikes.

FIG. 6 is a perspective view from the upper-rear-right of the bike rack of FIGS. 2-5, shown with the main beam in a lowered storage position.

FIG. 7 is a side view of the top half of the bike rack of FIGS. 2-6, shown with the main beam in the folded position of FIG. 5.

FIG. 8 is a side view of the top half of the bike rack of FIGS. 2-6, shown with the main beam in a lowered and folded storage position.

FIG. 9 is a perspective view of the top half of the bike rack of FIGS. 2-8, with the main beam in the extended position of FIGS. 2-4, but with the main top plate of the lower arm weldment and with the main top plate of the upper arm weldment hidden to better show underlying structures.

FIG. 10 is a perspective view of the top half of the bike rack of FIGS. 2-9, with the main beam arm in the folded position of FIGS. 5 and 7, but with the main top plate of the lower arm weldment and with the main top plate of the upper arm weldment hidden to better show underlying structures.

FIG. 11 is an exploded perspective view of the top half of the bike rack of FIGS. 2-11.

FIG. 12 is a first exploded perspective view of the bottom half of the bike rack of FIGS. 2-6.

FIG. 13 is a second exploded perspective view of the bottom half of the bike rack of FIGS. 2-6.

FIG. 14 is a cross-sectional view of the bottom half of the bike rack of FIGS. 2-6, taken just inside the right side wall of the main post tube.

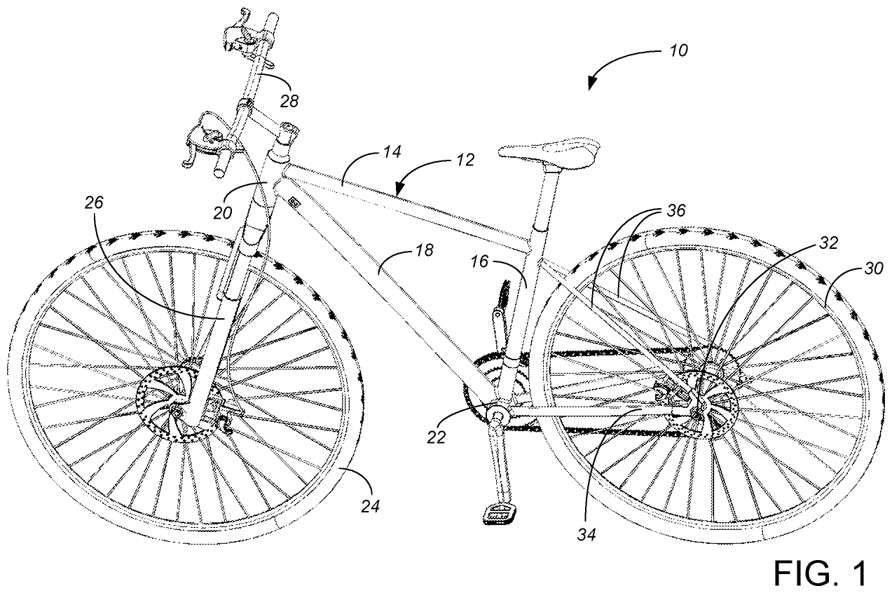

While the above-identified drawing figures set forth a preferred embodiment, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION OF THE PREFERRED EMBODIMENTS

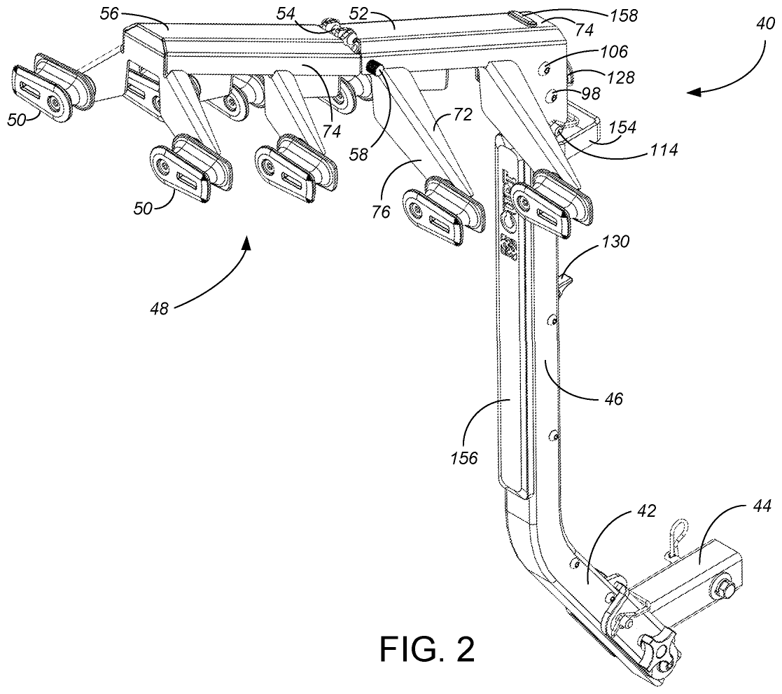

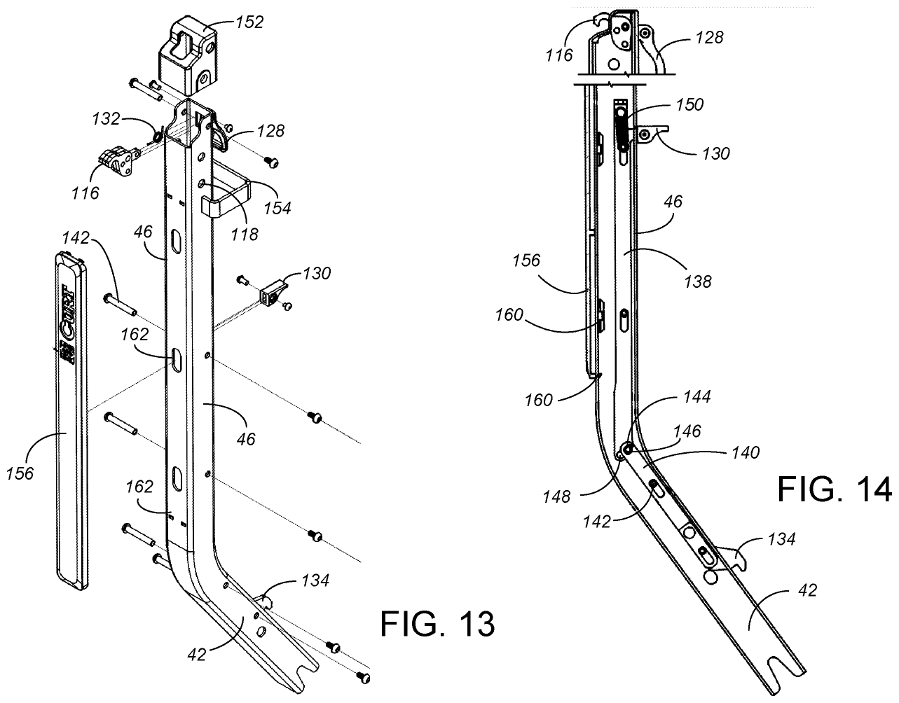

FIGS. 2-14 show a vehicle mounted bike rack 40 in accordance with a first preferred embodiment of the present invention. The leading end 42 (with directional terms such as “leading”, “trailing”, “horizontal”, “vertical”, “longitudinal”, “transverse”, “top”, “lower” etc., being defined in accordance with the direction and orientation of towing vehicle travel during use when mounted on the back of the towing vehicle) of the bike rack 40 is intended to be used with a quick mount adapter 44 described in U.S. patent application Ser. No. 17/535,092, filed on Nov. 24, 2021 and incorporated by reference. Thus, the leading end 42 enables the bike rack 40 to be lowered as shown in U.S. patent application Ser. No. 17/535,092 without requiring the user to use any tools, for better access to a rear tailgate, rear door, or rear hatchback of the towing vehicle above the leading end 42. The quick mount adapter 44 also allows ready removal of the bike rack 40 from the vehicle, again without requiring the use of any tools.

From the leading end 42, the hitch mounted bike rack 40 includes a main post 46 which extends upwardly and a main beam 48 extending rearwardly off of the main post 46 in a non-vertical orientation (for its primary usage position shown in FIGS. 2-4). A plurality of mounts 50 for hanging of one or more bikes 10 are positioned slightly lower than the main beam 48. While the mounts 50 could attach to the tops of the wheels 24, 30, more preferably the mounts 50 extend under and support the frame 12 of the bike(s) 10, such as by lifting the bike 10 and setting the toptube 14 onto and into two frame mounts 50. The frame mounts 50 could also contact either the seat tube 16, the downtube 18 or both, particularly depending upon the size of the bike 10. Preferably the frame mounts 50 allow usage with the toptube 14 extending substantially horizontally, for easiest lifting of the bike 10. One alternative mounting arrangement places one of the frame mounts 50 beneath the tops of the seat stays 36. The main beam 48 could extend substantially horizontally for its primary use position, but more preferably extends at an upward slope a in the trailing direction, such as at a slope of 10 to 60° to horizontal, with the preferred embodiment using a slope a of 25° to horizontal.

There are multiple bike hanging positions along the main beam 48, with the preferred embodiment having four bike hanging positions. Other embodiments (not shown) have one, two, three or more than four bike hanging positions. The frame mounts 50, preferably two per bike hanging position, extend underneath the main beam 48, referred to as being “underslung”. Each bike 10 is loaded onto the main beam 48 with its toptube 14 extending transversely under the main beam 48. Each bike hanging position is horizontally spaced from the others sufficient to provide side-to-side (longitudinal relative to the towing direction) clearance between the bikes, such as at a longitudinal spacing 1 from 3 to 12 inches, and in the most preferred embodiment the bike hanging positions have a consistent longitudinal spacing 1 of about 7 inches (180 mm) apart. With the 25° slope, this means that the forward bike hanging position has a vertical spacing v about 3 inches (76 mm) lower than the second bike hanging position and a vertical spacing 3 v of about 9 inches (228 mm) lower than the rearward bike hanging position.

When loading multiple bikes 10 onto the bike rack 40, the user starts with the forward bike hanging position and loads bikes from front (at a lower position) to back (at a higher position). As such, the user doesn't have to maneuver the bike frame 12 through multiple mounts 50 and the length of the main beam 48, but instead lifts the bike 10 to the appropriate height and then sets the bike 10 forward into the two frame mounts 50 for that bike hanging position. The user is able to hold the bike 10 closer to his or her body making it easier to lift and maneuver during loading. The upward angle a of the main beam 48 allows easier access under the main beam 48 and also creates a larger opening to access the frame mounts 50. The user ends up loading bikes 10 from the lowest to the highest position, i.e., a shorter elevation of lifting is required for loading the first bike 10 than subsequent bikes 10.

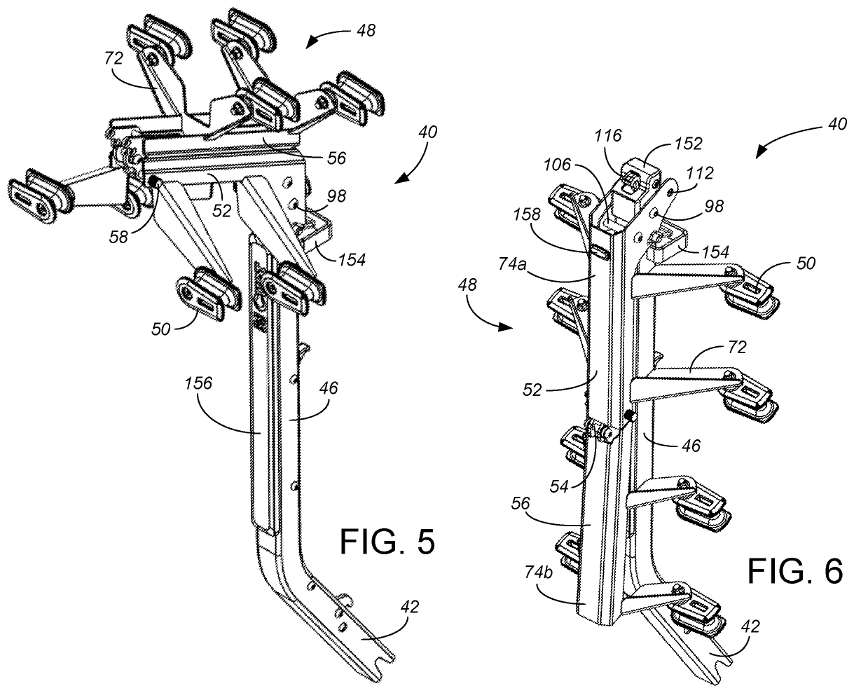

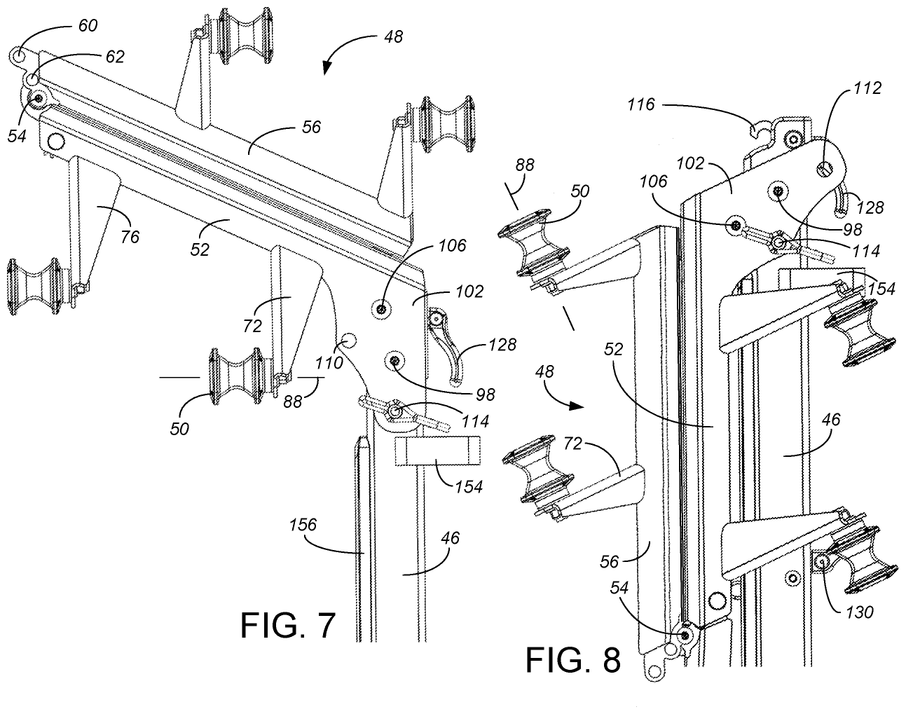

For the four bike embodiment, the main beam 48 is preferably foldable, into the position shown in FIGS. 5 and 7. The preferred main beam 48 thus includes a lower arm weldment 52 hingedly or otherwise pivotally connected by a pivot pin 54 to an upper arm weldment 56. In the folded position, the lower two bike mount locations can still be used. Flipping back the upper arm weldment 56 onto the lower arm weldment 52 allows easier access to the interior or forward frame mounts 50 and also makes the bike rack 40 less obstructive when the third and fourth mounting positions are not needed. Other embodiments can use more than one hinge along the length of the main beam 48.

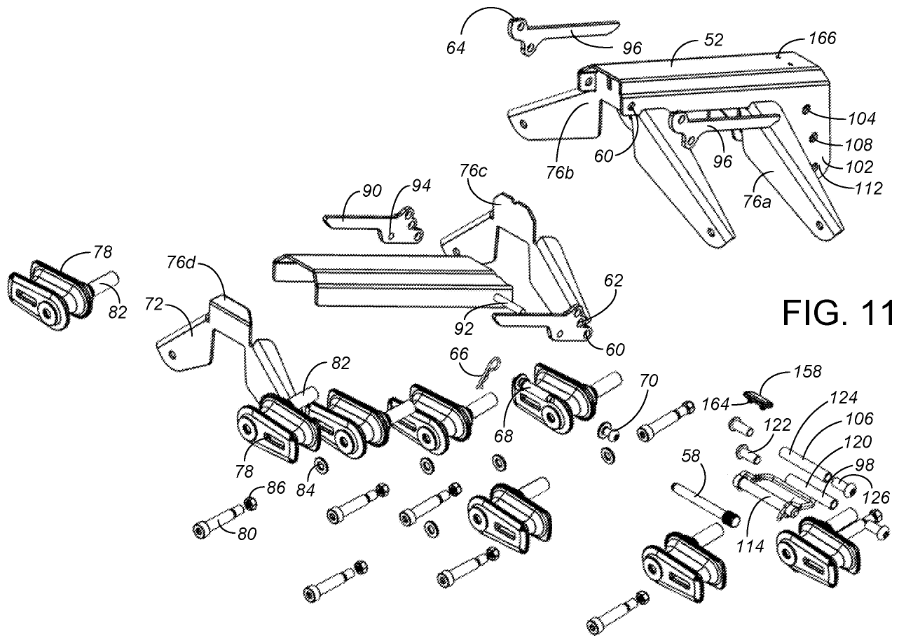

In the preferred embodiment, the main beam 48 can be secured either in the straight (extended) or folded position using a clevis pin 58 shown in its entirety in FIG. 11, without requiring the user to use any tools to move the main beam 48 between positions. The clevis pin 58 can be selectively inserted, either through a set of first position clevis pin holes 60 in both the lower arm weldment 52 and upper arm weldment 56 which align when the main beam 48 is in the straight (extended) position, or through a set of second position clevis pin holes 62 in the upper arm weldment 56. With the main beam 48 straight and the clevis pin 58 extending through all four first position clevis pin holes 60, the clevis pin 58 prevents pivoting of the upper arm weldment 56 relative to the lower arm weldment 52 so long as the clevis pin 58 remains in place. With the main beam 48 folded and the clevis pin 58 in the second position clevis pin holes 62, the clevis pin 58 contacts one or more clevis pin stops 64 on the lower arm weldment 52 to prevent pivoting (unfolding) of the upper arm weldment 56 relative to the lower arm weldment 52 so long as the clevis pin 58 remains in place. A cotter pin 66 can be used to secure the clevis pin 58. When the user desires to move the main beam 48 between straight and folded configurations, the user removes the cotter pin 66 and clevis pin 58, hand moves the upper arm weldment 56 relative to the lower arm weldment 52, and then resecures the clevis pin 58 and cotter pin 66. The preferred upper arm pivot pin 54 is provided by a 10 mm stainless steel binding barrel 68 and mating binding barrel screw 70, and the preferred clevis pin 58 is also a 10 mm stainless steel pin. These two 10 mm connections have been found sufficiently strong to transfer all of the weight and stress of the upper arm weldment 56 and the third and fourth bikes to the lower arm weldment 52, over years of use of the bike rack 40.

In the preferred embodiment, each frame mount 50 is pivotally or rotatably secured to a dropping side mounting arm 72, with the dropping side mounting arms 72 being part of the lower and upper weldments 52, 56. For instance, the main beam 48 can be formed from stamped, bent and welded sheet metal parts, including two top plates 74 and four mounting arm plates 76. Two mounting arm plates 76a, 76b can be welded to the top plate 74a for the lower beam arm 52, and two mounting arm plates 76c, 76d can be welded to the top plate 74b for the upper beam arm 56, providing the necessary rigidity and structure for both the upper arm weldment 56 and the lower arm weldment 52. In the preferred embodiment, the mounting arm plates 76 and the top plates 74 are both formed from 3 mm thick Q235 sheet steel, stamped/cut and bent into the configurations shown. Each mounting arm plate 76 provides two dropping side mounting arms 72. Each frame mount cushion 78 is pivotally secured to its dropping side mounting arm 72 using a shoulder bolt 80 extending through a hollow cylindrical cushion sleeve 82, fastened with a washer 84 and lock nut 86.

To protect the frame 12 of the bike 10, the frame mount cushions 78 are made of a material which is softer than metal, and preferably a polymer, and most preferably a non-scuffing polyurethane or thermoplastic polyether-ester elastomer (TPEE) such as at a durometer of Shore 60A. The geometry of the preferred frame mount cushions 78 is oblong, with the axis 88 of the shoulder bolt 80 and sleeve 82 being offset relative to a midpoint of the oblong shape, enabling the frame mounts 50 to be able to be selectively rotated to adapt to different bike frame geometries and sizes. To further support and hold the bikes 10 in place on the frame mounts 50, releasable flexible cable ties (not shown) may be included to secure the bike frame 12 within the curved surface of the frame mount cushions 78. For instance, eight polyester straps, one for each frame mount 50, can be included, each with a chrome plated steel buckle and hook and loop material (VELCRO) ends to adjust length.

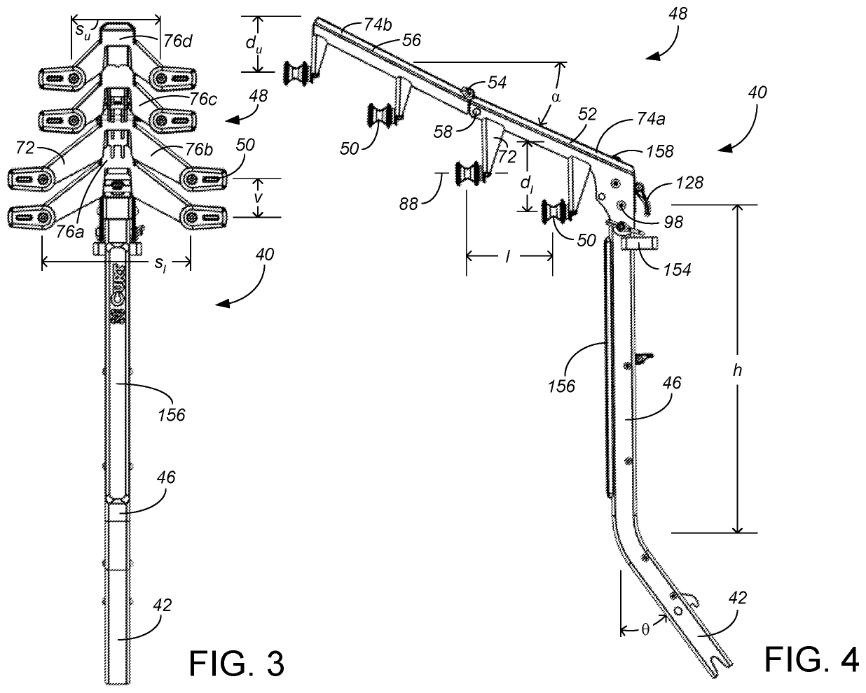

As best shown in FIG. 3, the frame mounts 50 on the lower arm weldment 52 preferably have a different transverse or lateral spacing s₁ than the spacing sᵤ of the frame mounts 50 on the upper arm weldment 56. If all four positions are used, then larger and heavier bikes 10 should generally occupy the lower bike positions, with smaller and lighter bikes 10 used on the upper bike positions, thereby resulting in less lifting of the greater bike weight. In the preferred embodiment shown, the frame mounts 50 on the upper arm weldment 56 have a pivot axis spacing sᵤ of about 185 mm, with the frame mount pivot axis having a drop dᵤ of about 118 mm lower than the top of the upper arm top plate 74b. Meanwhile, the frame mounts 50 on the lower arm weldment 52 have a pivot axis spacing s₁ of about 315 mm, with the frame mount pivot axis having a drop d₁ of about 150 mm lower than the top of the lower arm top plate 74a.

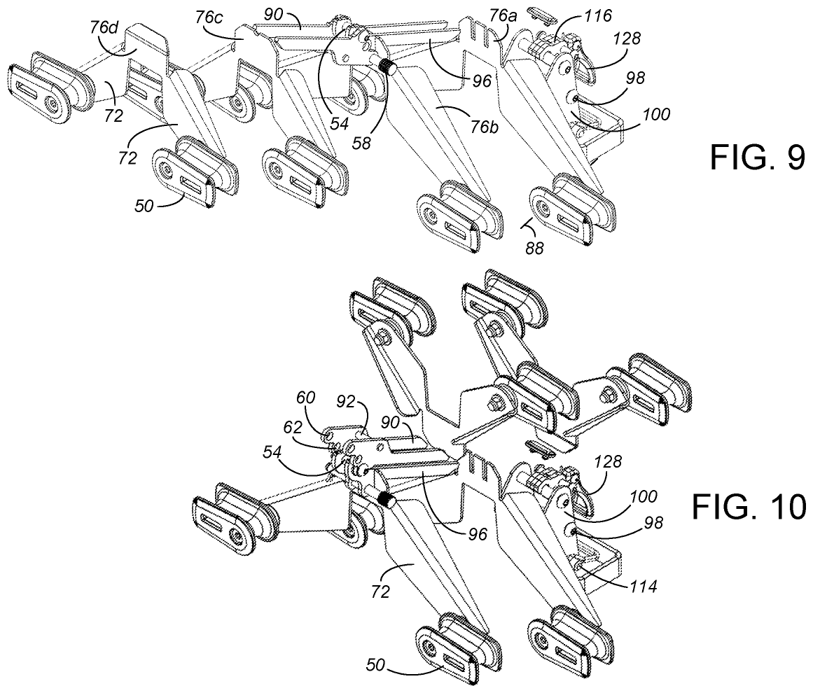

FIGS. 9-11 best show the hardware used for the pivotal connection between the upper weldment arm 56 and the lower weldment arm 52. Namely, two distal hinge supports 90 are connected with a reinforcement pin 92 through reinforcement pin holes 94 and then welded to the upper top plate 74, and two proximal hinge supports 96 are welded to the lower top plate 74. The distal hinge supports 90 and the proximal hinge supports 96 both run longitudinally, with a height greater than their width, thereby acting as beams which significantly increase the bending strength of the upper weldment arm 56 and the lower weldment arm 52 to hold with weight of the bikes 10. In the preferred embodiment, the distal hinge supports 90 and the proximal hinge supports 96 are formed from 5 mm thick Q235 plate steel with a height of about 14 mm.

In addition to the preferred folding between the upper arm weldment 56 and the lower arm weldment 52, the main beam 48 can be folded down in its entirety, to a vertical orientation parallel to the support post 46 as shown in FIG. 6. More precisely, the lower weldment arm 52 preferably has a pivotal attachment to the support post 46, pivoting about a main beam pivot pin 98. Reinforcement plates 100 are welded to downwardly extending ears 102 of the top plate 74 to help support the weight and stress of this connection. The preferred reinforcement plates 100 are formed of 3 mm thick Q235 sheet steel. The reinforcement plates 100 and the downwardly extending ears 102 have four sets of holes (104, 108, 110 and 112) therethrough, one set 104 for a latching pin 106, one set 108 for the main beam pivot pin 98, and two sets 110, 112 for selectively receiving a coupler pin 114. A latching pin 106 is provided, preferably welded through the ears 102 of the top plate 74 and the reinforcement plates 100 and spaced on one side of the main beam pivot pin 98. Upon rotation of the lower arm weldment 52 upwardly, a central portion of the latching pin 106 mates into a spring loaded latch 116. A coupler pin 114 is also provided, which can mate through a set of coupler pin openings 118 in the post 46. The coupler pin 114 can be placed either through the coupler pin holes 110 and into the coupler pin openings 118 to hold the lower arm weldment 52 downwardly as shown in FIGS. 6 and 8, or through the coupler pin holes 112 and into the coupler pin openings 118 to hold the main beam 48 upwardly as shown in FIGS. 2-5 and 7. The ability to fold down the bike rack main beam 48 makes the bike rack 40 more compact for travel and storage purposes. The preferred main beam pivot pin 98 is provided by a 12.5 mm stainless steel binding barrel 120 and mating binding barrel screw 122, the preferred latching pin 106 is provided by a 12.5 mm stainless steel binding barrel 124 and mating binding barrel screw 126, and the preferred coupler pin 112 is also a 12.5 mm stainless steel pin. These three 12.5 mm connections have been found sufficiently strong to transfer all of the weight and stress of the main beam 48 arm and four bikes 10 to the post 46, over years of use of the bike rack 40.

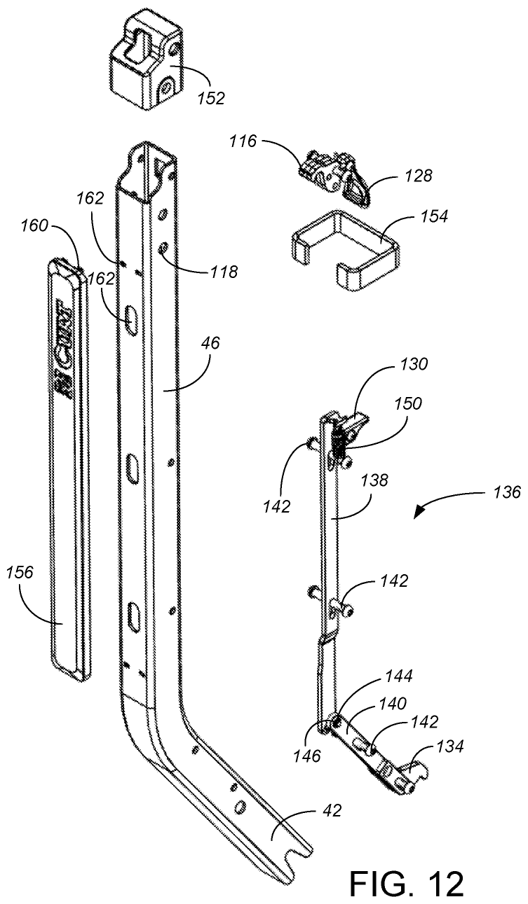

The component parts of the post 46 are best shown in FIGS. 12-14. The main post 46 and the leading end 42 are preferably jointly formed by bending of steel rectangular tubing. In the preferred embodiment, the post 46 extends at an angle θ of about 36° relative to the leading end 42, upwardly for a height h of the main beam pivot pin 98 of about 670 mm higher than the bend. The most preferred embodiment uses 50×50 mm square tubing, formed of Q235 steel with a 3 mm wall thickness.

The main post 46 includes two moveable levers 128, 130. A top lever 128 moves the latch 114 against a torsion spring 132, for unlatching the latching pin 106 of the main beam 48 whenever the user desires to move the lower arm 62 from the extended bike-supporting position to the lowered, vertical storage position. A lower lever 130 moves the adapter latch 134. The lower lever 130 is preferably positioned high in the post 46 for ease of access, but connected to the adapter latch 134 via a linkage 136 which is positioned within the tube. The preferred linkage 136 includes a vertical link 138 and a slanted link 140, each riding on two shoulder bolts 142 through the tube. The vertical link 138 can move vertically within the post 46, while the slanted link 140 can move within the leading end 42 at an angle that matches the angled orientation of the leading end 42. The vertical link 138 and the slanted link 140 are connected together such as by a clevis pin 144 and retaining ring 146. The clevis pin 144 extends through an oblong opening 148 in at least one of the vertical link 138 and the slanted link 140, enabling relative movement between the vertical link 138 and the slanted link 140 during unlatching from the quick mount adapter 44. A tension spring 150, which can be anchored on the uppermost shoulder bolt 142, biases the linkage 136 downwardly, and the force of this spring 150 must be overcome by the lower lever 130 to raise the adapter latch 134. In the most preferred embodiment, each of the two moveable levers 128, 130 are molded from polymer, such as from a UV-stabilized blend of polycarbonate (PC) and acrylonitrile butadiene styrene (ABS), thereby resulting in a more comfortable unlatching experience on the user's hands. A top cap 152 is also provided at the top of the post 46, primarily for user safety and dirt protection, which can be similarly molded from the UV-stabilized PC and ABS blend. The links 138, 140 can all be formed of Q235 steel plate material.

A handle 154 is preferably rigidly attached to the post 46. For instance, the handle 154 can be formed by bending a 5 mm×25 mm Q235 steel plate strap into the configuration shown and welding it to the post tube 46. The handle 154 is useful both for lifting the bike rack 40 when positioning the bike rack 40 relative to the quick mount adapter 44, and for leverage when manipulating either of the levers 128, 130.

The most preferred embodiment includes two bumpers 156, 158, formed of a material softer than the post 46 and the main beam 48. The first bumper 156 is attached, such as by having extensions 160 which snap into holes 162 in the post 46, so as to be positioned between the main beam 48 and the vertical post 46 and maintain separation between the main beam 48 and the vertical post 46 when the main beam 48 is folded down. This bumper 156 also helps to protect both the first bike 10 and the vertical post 46 from damaging contact during loading of the first bike 10 and during vehicle travel. The second bumper 158 is attached, such as by having extensions 164 which snap into holes 166 in either the upper weldment 56 or more preferably the lower weldment 52, so as to be positioned between the two weldments 52, 56 and maintain separation between the two weldments 52, 56 when flipped together as shown in FIGS. 5, 7, and 8. For instance, the bumpers 156, 158 can be molded of a non-scuffing polyurethane or thermoplastic polyether-ester elastomer (TPEE) such as at a durometer of Shore 60A. The bumper 156 in particular can be molded to have indicia such as a trademark or product name on it.

The resulting bike rack 40 is relatively inexpensive while still being robust and simple to use when the user desires to move the bike rack 40 between different positions. Use of the bike rack 40 results in easier lifting operations for the user to load and unload bikes 10. The illustrated and discussed embodiments are light in weight and are simpler and lower in cost than many prior art designs.

Although the present invention has been described with reference to preferred embodiments, workers skilled in the art will recognize that changes may be made in form and detail without departing from the spirit and scope of the invention. In particular, all of the dimensions and materials, unless included in the claims, are exemplary only.

1. A bike rack mountable from a hitch receiver of a towing vehicle, comprising:
a post extending substantially vertically;
a main beam supported by the post and extendable so as to slant rearwardly and upwardly from a top of the post; and
a plurality of mounts supported by the main beam for hanging at least one bike with a toptube of the bike extending substantially horizontally and transversely beneath the main beam.

2. The bike rack of claim 1, wherein the main beam is pivotally connected to the post, allowing pivoting between a storage position where the main beam runs parallel to the post and a usage position where the main beam slants rearwardly and upwardly from a top of the post.

3. The bike rack of claim 2, further comprising a pin which can be selectively inserted, either in a first location relative to at least one of the post and the main beam to hold the main beam in the usage position or in a second location relative to at least one of the post and the main beam to hold the main beam in the storage position.

4. The bike rack of claim 2, further comprising:
a spring-loaded latch for holding the main beam in the usage position; and
a lever for releasing the spring-loaded latch.

5. The bike rack of claim 2, further comprising a bumper which protects the main beam in the storage position from contact with the post, the bumper being formed of a material which is softer than the main beam and softer than the post.

6. The bike rack of claim 1, wherein the main beam comprises a lower arm pivotally attached to an upper arm, with a plurality of mounts supported by the lower arm for hanging at least one bike with its toptube below the lower arm, and a plurality of mounts supported by the upper arm for hanging at least an additional bike with its toptube below the upper arm.

7. The bike rack of claim 6, wherein four mounts are supported by the lower arm for hanging first and second bikes, and wherein four mounts are supported by the upper arm for hanging third and fourth bikes.

8. The bike rack of claim 6, wherein the plurality of mounts supported by the lower arm are spaced laterally further apart than the plurality of mounts supported by the upper arm.

9. The bike rack of claim 6, wherein the lower arm comprises a lower arm weldment with a lower arm top plate and at least lower arm one hinge support having a height greater than its width and welded to the lower arm top plate, and wherein the upper arm comprises an upper arm weldment with an upper arm top plate and at least one upper arm hinge support having a height greater than its width and welded to the upper arm top plate.

10. The bike rack of claim 9, wherein the lower arm weldment comprises at least one mounting arm plate supporting two of the mounts at laterally spaced locations.

11. The bike rack of claim 6, further comprising a pin which can be selectively inserted, either in a first location relative to at least one of the upper arm and the lower arm to hold the main beam in an extended position or in a second location relative to at least one of the upper arm and the lower arm to hold the main beam in a folded position.

12. The bike rack of claim 6, further comprising a bumper which protects the upper arm in the folded position from contact with the lower arm, the bumper being formed of a material which is softer than the upper arm and softer than the lower arm.

13. The bike rack of claim 1, wherein the mounts comprise oblong mount cushions which are pivotable relative to the main arm.

14. The bike rack of claim 1, further comprising:
a quick mount adapter latch; and
a linkage within the post, the linkage being usable to release the quick mount adapter latch.

15. The bike rack of claim 14, further comprising:
a spring for biasing the linkage; and
a lever for moving the linkage against the spring force for releasing the quick mount adapter latch.

16. The bike rack of claim 1, comprising a leading end for supporting the bike rack relative to the hitch receiver, and wherein the leading end and the post are integrally formed by bending a tube.

17. A bike rack mountable from a hitch receiver of a towing vehicle, comprising:
a post extending substantially vertically;
a main beam supported by the post and extendable rearwardly from a top of the post; and
a plurality of frame mounts supported by the main beam for hanging at least one bike by contacting and supporting a toptube of the bike, with the toptube running substantially horizontally and transversely relative to the main beam.

18. The bike rack of claim 17, wherein the plurality of mounts comprise a first set of frame mounts and a second set of frame mounts, and wherein the first set of frame mounts are spaced laterally further apart than the second set of frame mounts.

19. A method of mounting a bike from a receiver hitch of a towing vehicle, comprising:
attaching a bike rack to the receiver hitch of the towing vehicle, the bike rack comprising:
a post extending substantially vertically;
a main beam supported by the post and extendable rearwardly from a top of the post, wherein the main beam comprises a distal arm pivotally attached to a proximal arm such that the distal arm can be moved between a first position and a second position relative to the proximal arm;
at least one proximal arm mount supported by the proximal arm for hanging at least a first bike with its toptube running substantially horizontally and transversely relative to the proximal arm; and
at least one distal arm mount supported by the distal arm for hanging at least a second bike with its toptube running substantially horizontally and transversely relative to the distal arm;
lifting the first bike into position so as to be supported by the proximal arm mount while the distal arm is in the first position;
moving the distal arm from the first position to the second position; and
lifting the second bike into position so as to be supported by the distal arm mount in the second position.

20. The method of claim 19, further comprising:
after moving the distal arm from the first position to the second position, inserting a pin to hold the distal arm in the second position.
